(19) United States
(12) Patent Application Publication
(10) Pub. No.: US 2023/0148274 A1
(43) Pub. Date: May 11, 2023

(54) Protective Device for an Electronic Component Connected to an Interface

(71) Applicant: Robert Bosch GmbH, Stuttgart (DE)

(72) Inventors: Mickael Segret, Stuttgart (DE); Holger Wernerus, Pliezhausen (DE)

(21) Appl. No.: 17/906,700

(22) PCT Filed: Feb. 12, 2021
(86) PCT No.: PCT/EP2021/053490

§ 371 Date: Sep. 19, 2022

(30) Foreign Application Priority Data
Mar. 20, 2020 (DE) 10 2020 203 583.0

(51) Int. Cl. H01M 10/48; H01M 10/637; H01M 50/581; H02H 7/18

(52) U.S. Cl. CPC H01M 10/486; H01M 10/482; H01M 10/637; H01M 50/581; H02H 7/18; H01M 2200/105; H01M 2200/106

(57) ABSTRACT

A protective device for an electronic component is connected to an interface and includes a compensation element connected in series with the electronic component. The compensation element has a positive temperature coefficient of its electrical resistance. The compensation element is connected to a pole or measuring contact of an electrical energy accumulator. The electronic component and the compensation element are thermally coupled to one another.

The present invention relates to a device for an electronic component connected to an interface. The invention further relates to a method for operating a protective device for an electronic component connected to an interface.

### PRIOR ART

Electrochemical energy sources, for example accumulator cells, permit mobile access to electric power, with no connection to a grid system. At present, a frequently employed type of cell is a lithium-ion cell, which combines good energy density and power density. Common forms of construction are cylindrical cells, prismatic cells or pouch cells.

In order to permit the safe operation of a lithium-ion cell, it is necessary for the temperature thereof to be monitored, and for operating parameters to be configured in a temperature-dependent manner. For the detection of temperature, various temperature sensors are employed. It is important that the sensor should assume the closest possible thermal contact with the lithium-ion cell.

Accumulator packs are known, in which a temperature sensor is fitted to a flexible circuit board and, together with the circuit board, is compressed onto a cell by means of an elastic element. This arrangement supports the most intimate possible thermal connection between the temperature sensor and a cell.

In many cases, a sensor is employed as a temperature sensor, the ohmic resistance of which varies according to temperature. If this resistance is lower at higher temperatures, this is described as a NTC (negative temperature coefficient). In many cases, this temperature sensor is located in the battery pack but, in an equipment system with an interchangeable battery pack, measurement and evaluation is executed by means of the charging device or the discharged electrical device. This measurement is typically executed by the application of a voltage to the temperature sensor via a series resistor, and the measurement and evaluation of the voltage drop across the series resistor and the temperature sensor.

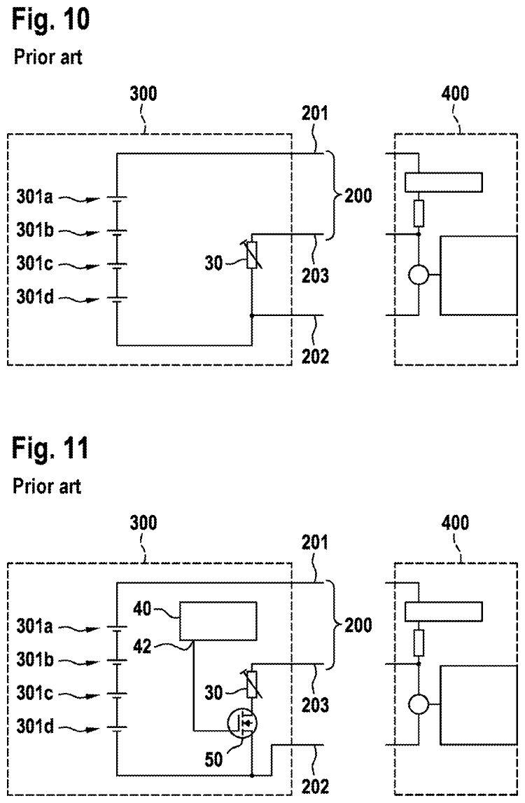

FIG. 10 shows an electrical energy store 300 in the form of an accumulator pack with individual cells 301a, . . . 301d, which are connected to a management apparatus 400 (e.g. a charging device) via an interface 200.

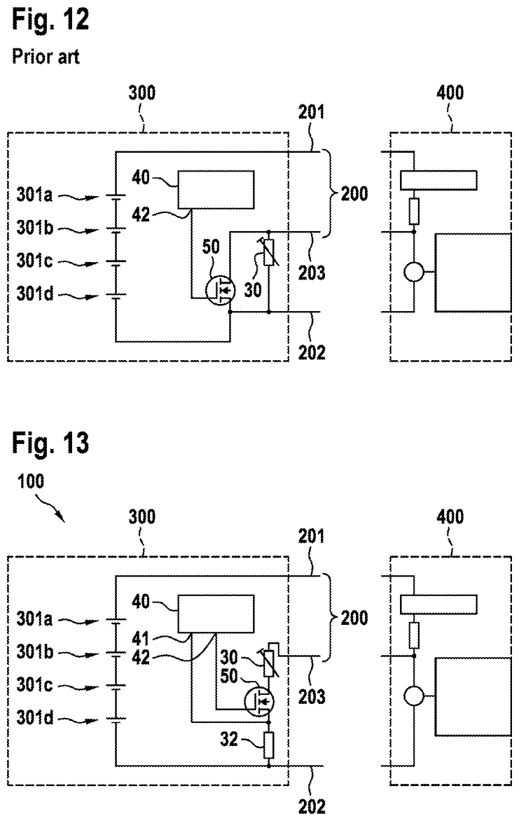

In the meantime, international standards now require that, during charging, individual cell voltages in a battery pack comprised of a plurality of cells are to be monitored. In order to permit the communication of a trip signal in the event of a fault, it is customary for the temperature sensor to be invalidated. This can be achieved, for example, by means of an electronic switch 50 connected in series with the NTC temperature sensor 30 (see FIG. 11), or by means of an electronic switch 50 connected in parallel with the NTC temperature sensor 30, the principle of which is illustrated in FIG. 12.

To this end, it is intended that a monitoring apparatus 40, in the form of electronics for the monitoring of individual cell voltages, should be installed in the battery pack. In order to prevent the discharging of the battery pack, in the resting state, by the monitoring apparatus 40, it is customary that the monitoring apparatus 40 is only switched on if the battery pack is in service, for example if a voltage is present on the NTC temperature sensor 30.

In order to limit electric current in the event of a fault, it is also possible e.g. for fuses to be employed. These convert a proportion of the electric current flowing through the resistor, and the associated voltage drop, into thermal energy, thus permitting the melting of a conductive material and the interruption of the electric current flow. In principle, the lower the rated current to be tripped, the higher the resistance rating required. Another option for the limitation of electric current is the employment of a transistor, in conjunction with a resistor, by way of a current source. The current flow associated with a voltage drop across the resistor counteracts the control voltage of the transistor, thereby establishing an equilibrium and thus a defined electric current.

As represented in FIG. 11, a monitoring apparatus 40 is known having integrated circuits, which is employed for the monitoring of operating states within the electrical energy store 300. This apparatus comprises, for example, inputs for the monitoring of individual cell voltages, temperature or current. If specification limits for a parameter are breached, circuits of this type trigger an alarm. This typically takes the form of a level change, wherein a pin switches from a low logic state to a high logic state, or vice versa.

If a NTC temperature sensor is employed, the following problems can occur in the event of improper use or severe contamination:

The measuring contact 203, to which the electronic component 30 in the form of the NTC temperature sensor is connected, conversely to its specified function, is connected to the positive pole 201 of the electrical energy store 300 (e.g. by metal components). As a result, the monitoring apparatus 40 is switched on, and spuriously detects a normal operating state (an electric voltage on temperature sensor 30). As the voltage is applied directly to the temperature sensor 30, rather than via a series resistor, current limitation is only executed by the resistance of the NTC temperature sensor 30. The NTC temperature sensor 30 undergoes heat-up as a result of the power thus converted, thereby resulting in a lower NTC resistance and, in turn, an increase in the power converted (by way of direct feedback in a vicious circle).

As the NTC temperature sensor is in intimate thermal contact with the cells 301a . . . 301d, a hot spot occurs on the corresponding cells 301a . . . 301d, which can result in a thermal imbalance, and can disadvantageously cause the more rapid ageing of the electrical energy store 300.

In addition, conventional methods for the limitation of electric current, on the grounds of the necessity of a resistance for this purpose, are invariably associated with a corruption of the temperature signal. Electric current flowing in the event of a fault can be relatively low, for example 50 mA, but can nevertheless result in high temperatures. A fuse with a current rating of 50 mA typically has a resistance of 10 ohms. Installation thereof would result in the corruption of the temperature signal.

### DISCLOSURE OF THE INVENTION

The object of the present invention is the provision of an improved protective device for a protective element.

According to a first aspect, this object is fulfilled by a protective device for an electronic component connected to an interface, comprising:
a compensation element connected in series with the electronic component; wherein
the compensation element has a positive temperature coefficient of its electrical resistance, and wherein the compensation element is connected to a pole of an electrical energy store via the interface; wherein
the electronic component and the compensation element are thermally coupled to one another.

According to a second aspect, this object is fulfilled by a method for producing a protective device for an electronic component connected to an interface, wherein an electrical energy store is connected to the interface, comprising the following steps:
Connection of the component to a pole or measuring contact of the electrical energy store;
Serial connection of a compensation element between one pole of the electrical energy store and the electronic component, or between the electronic component and a measuring contact, wherein the compensation element assumes a positive temperature coefficient of the electrical resistance; and
Wherein the component and the compensation element are thermally coupled to one another.

Advantageous configurations of the protective device are the respective subject matter of the dependent claims.

According to an advantageous further development of the proposed protective device, the electronic component is a NTC or coding resistor. In this manner, advantageously, different types of electronic components can be protected by means of the proposed protective device.

An advantageous further development of the proposed protective device provides that thermal coupling is provided by means of a specific spatial proximity, or by a connection in the form of a printed electrical conductor, or by means of a specific heat transfer resistance between the component and the compensation element. In this manner, advantageously, different means for the provision of thermal coupling are possible.

Another advantageous further development of the proposed protective device is characterized in that thermal coupling between the electronic component and the compensation element is conducive to the tripping of the compensation element by the heat-up of the electronic component. In this manner, the PTC can deploy its current-limiting action in the event of the heat-up of the NTC.

Another advantageous further development of the proposed protective device is characterized in that the electronic component is employed for temperature measurement, wherein the electronic component and the compensation element, with respect to their temperature coefficients, are mutually tuned such that, within a relevant temperature measurement range, a temperature measurement is not significantly corrupted and wherein, outside the relevant temperature measurement range, the compensation element is defined as high-resistance. In this manner, support is advantageously provided to the effect that a temperature measurement by means of the electronic component, in the form of a NTC, is not significantly corrupted by the compensation element.

Another advantageous further development of the proposed protective device is characterized in that the relevant temperature measurement range lies between approximately −20° C. and approximately +80° C. Advantageously, a relevant temperature measurement range is thus defined for the protective device, which operates for the protection of a component which functions as a temperature sensor.

Another advantageous further development of the proposed protective device is characterized in that an equilibrium temperature of the electronic component and the compensation element is such that, at the maximum operating voltage of an electrical energy store, cells of the electrical energy store are not endangered, wherein the equilibrium temperature thus established is dependent upon the point of intersection of the gradients of characteristic curves for the component to be protected and the compensation element. In this manner, an efficient protective action for the component, which functions as a temperature sensor, is advantageously supported by means of the compensation element.

Another advantageous further development of the proposed protective device is characterized in that a temperature measurement error associated with the resistance measurement of the electronic component and the compensation element, within the entire temperature working range of the electrical energy store, is established at a maximum defined value.

Another advantageous further development of the proposed protective device is characterized in that a resistance value of the compensation element is defined as small vis-à-vis a resistance value of the component which is to be protected. As a result, any interference of the compensation element with the component which functions as a temperature sensor is advantageously minimized.

Another advantageous further development of the proposed protective device is characterized in that an error in temperature measurement generated by the compensation element is not greater than 5% and, in particular, is not greater than 1%.

Another advantageous further development of the proposed protective device is characterized in that the electronic component and the compensation element are coupled by means of a thermally conductive material. Efficient thermal coupling between the electronic component and the compensation element is supported accordingly.

Another advantageous further development of the proposed protective device is characterized in that the electronic component and the compensation element are configured in the form of SMD components, wherein the electronic component and the compensation element comprise at least one common copper surface, which is designed for heat transfer. In this manner, a particularly space-saving design of the protective device, with simultaneously efficient thermal coupling, is supported.

The invention, together with further features and advantages thereof, is described in detail hereinafter with reference to a number of figures. The figures have been conceived for the clarification of key principles of the invention, and are not necessarily true to scale. In the interests of greater clarity, it can be provided that not all reference symbols are plotted in all the figures.

Features of the apparatus disclosed proceed, in an analogous manner, from the corresponding features of the method disclosed, and vice versa. In particular, this means that features, technical advantages and embodiments of the protective device proceed, in an analogous manner, from corresponding embodiments, features and advantages of the method for producing a protective device for an electronic component connected to an interface, and vice versa.

In the figures:

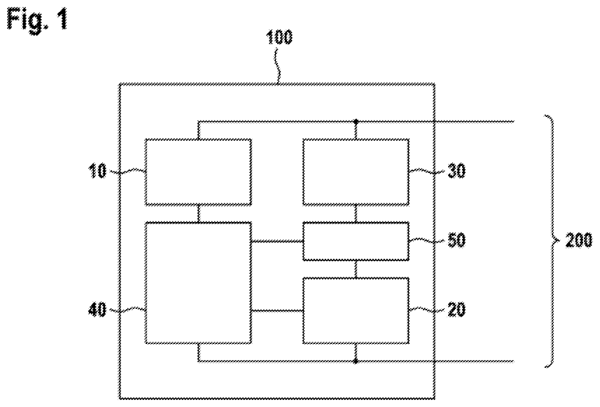

FIG. 1 shows a schematic block circuit diagram of a proposed protective device;

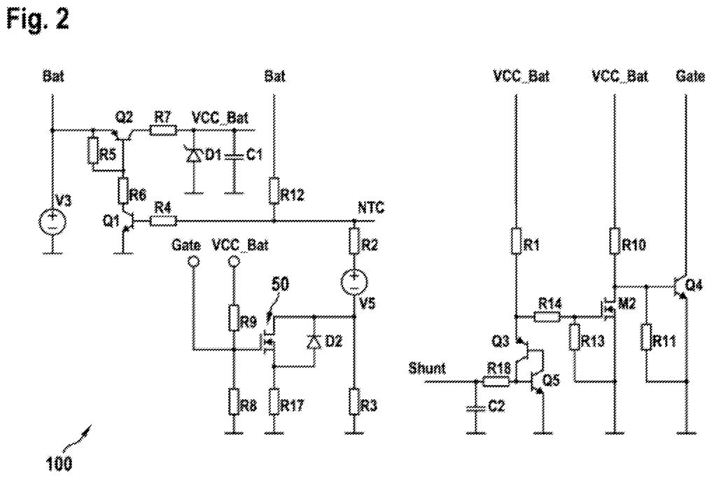

FIG. 2 shows a first embodiment of a proposed protective device;

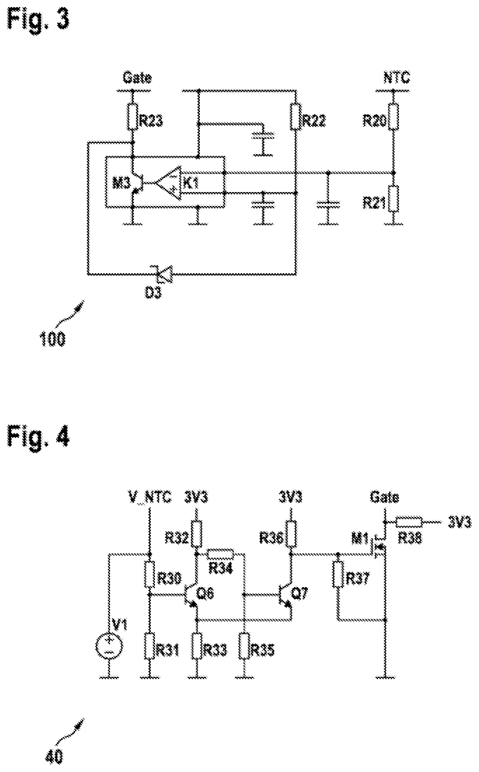

FIG. 3 shows a further embodiment of a proposed protective device;

FIG. 4 shows a further embodiment of a proposed protective device;

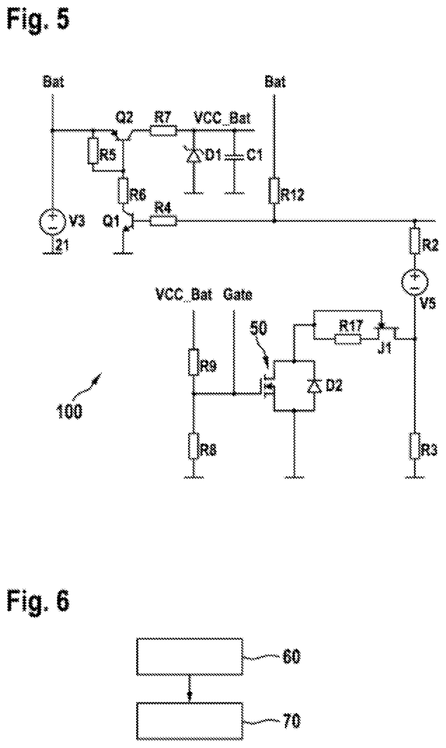

FIG. 5 shows a further embodiment of a proposed protective device;

FIG. 6 shows a schematic sequence of a method for operating a proposed protective device;

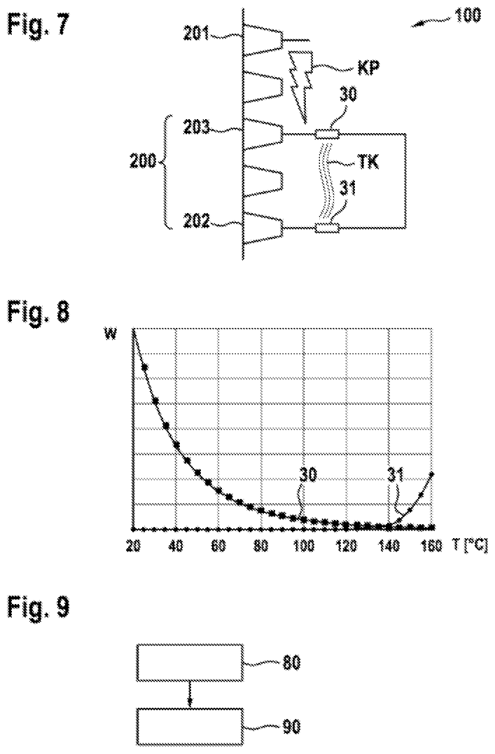

FIG. 7 shows a block circuit diagram of a further embodiment of a proposed protective device;

FIG. 8 shows a diagram with characteristic temperature curves for an element to be protected and the compensation element;

FIG. 9 shows a sequence diagram of a method for operating the protective device;

FIGS. 10-12 show conventional arrangements for the protection of an electrical energy store;

FIGS. 13-15 show embodiments of a protective device for an electronic component connected to an interface; and

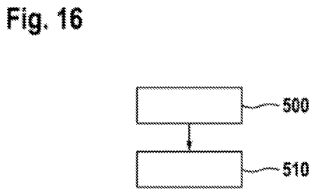

FIG. 16 shows a sequence diagram of a method for operating a protective device for an electronic component connected to an interface.

### DESCRIPTION OF EMBODIMENTS

A key concept of the present invention is the provision of a protective device for an electronic component to be protected, which is connected to an electrical interface.

Advantageously, by means of the proposed protective device, it is possible for the occurrence of damage to a component or subassembly which is connected to the interface to be prevented at any time.

To this end, it is proposed e.g. that an electric current be suppressed with virtually no corruption of a temperature signal during the rated operation of an electronic component which is employed as a temperature detection element. To this end, it is proposed that the electric current be detected by the electronic component and, optionally, is interrupted by means of a switching device which, in general and advantageously, is already present.

Alternatively, the electronic component to be protected can also be bridged, such that a high electric current trips a fuse having a high rated current, and thus a low resistance.

Advantageously, by means of the proposed protective device, it is possible to protect circuit components which are connected and connectable to an electrical interface, such as e.g. portable power tools, battery packs or similar. The proposed protective device comprises at least one sensor (current or voltage sensor), which can execute the high-resistance disconnection of the connected electronic component or the connected circuit.

In the present context, “high resistance” is understood as a state in which no damage occurs to the electronic component or to the electronic subassembly, or in which there is no conversion, or only a very limited conversion of energy. Moreover, the term “high resistance” can be understood as an increase in the overall resistance by a factor of at least 3 and, particularly advantageously, by a factor of at least 20, in relation to a nominal resistance. In particular, to this end, an electric current flux through the electronic component or the electronic subassembly is sufficiently limited. In the event that “high-resistance” disconnection is no longer required, the electronic component or circuit element can be reconnected (by automatic resetting), or the impedance can be reduced.

Information as to whether disconnection is to be executed is delivered by the sensors. A monitoring apparatus compares this information with at least one specifically-defined value and, in general, initiates “high-resistance” disconnection in the event of an overshoot, wherein an overshoot applies, for example, in the event that information delivered by the sensor departs from, or exceeds an appropriate and customary operating range.

A key advantage of the proposed protective device is particularly provided, in that disconnection of the electronic component to be protected, or of the electronic subassembly to be protected (e.g. an accumulator pack), is executed before any damaging rise in temperature occurs.

A first category of variants of embodiment of the proposed protective device provides for a measurement of an electric voltage at the interface. It is thus possible to react to the presence of an electric voltage which lies outside a defined operating voltage range within a very short response time. If the electric voltage lies outside the specified operating voltage range, the electronic component (e.g. the NTC or coding resistor) or the electronic switching assembly undergoes high-resistance disconnection from the interface and/or from a common reference potential (e.g. ground).

Advantageously, as a result, no latch circuit is required, as the electric voltage further to disconnection does not drop as a result of an increase in impedance. Customarily, after the disconnection process, the electric voltage of the electronic component or the electronic subassembly remains constant, or even increases. Consequently, for the proposed protective device, in general, only limited hysteresis, or even no hysteresis is required.

Embodiments of the proposed protective device are described in greater detail hereinafter, with reference to the above-mentioned first category of variants of embodiment.

FIG. 1 shows a block circuit diagram of a proposed protective device 100 for an electrical interface 200, to which an electronic component 30 to be protected (e.g. a NTC or coding resistor) is connected. A monitoring apparatus 40 can be seen, which cooperates functionally with a voltage detection apparatus 10, a current detection apparatus 20 and an electronic switch 50. In practice, by means of the proposed protective device 100 for the interface 200, it is possible, in the event of a fault, for the electronic component 30 which is to be protected or the subassembly which is to be protected to undergo high-resistance disconnection from the interface 200, and to be reconnected to the interface 200 once the fault has been cleared. In the event of a fault, it is conceivable that an electric voltage will be injected at a terminal of the electronic component 30 which is to be protected, in the form of a NTC, e.g. by means of a short-circuit which is permitted by the presence of metal dust. Thus, in general, the electric voltage and impedance are not entirely known.

In response to the resulting flow of electric current in the component 30 which is to be protected, in the form of a NTC, the NTC resistance declines rapidly, wherein e.g. the electric current can rise from an original value of approximately 10-21 mA to approximately 100 mA. This results in the self-heating of the NTC, and thus an associated reduction in the NTC resistance value. In a very hot NTC (e.g. 100 ohms for a NTC, the resistance of which at room temperature is 6.8 kiloohms), at a terminal voltage of 10 V, a current of up to 100 mA can be achieved at the interface 200, which constitutes a loading limit for a switch-off MOSFET. In practice, any electric voltages in excess of the order of 10 V at the interface 200 should be prevented, wherein an electric activation voltage can be significantly higher.

In the first category of variants of embodiment, voltage measurement is proposed at the input of the electronic component 30 to be protected. Nominally, an electric voltage at the interface 200 can be a maximum 5.0 V. A very high-resistance tap-off of a voltage, using a comparator or a MOSFET, is provided, as a result of which an exceptionally rapid detection of the electric voltage on the interface 200 is possible.

For the detection of the electric voltage drop on the electronic component 30 to be protected, a small-signal

MOSFET with a voltage divider and/or a RC filter can also be employed, which detects an overshoot in excess of 7 V on a pin of the electronic component 30 which is to be protected.

FIG. 2 shows an embodiment of a proposed protective device 100 for an electrical interface 200. On the upper left-hand side, a circuit section can be seen, which is provided by way of a simulation of the protective device 100. A terminal of the component 30 which is to be protected can be seen, which is identified as “NTC”.

An electric voltage V5 can be seen, which is generated in response to a current flux or self-heating in the electronic component 30 which is to be protected, in the form of a NTC.

By means of a gate terminal, high-resistance disconnection of the component 30 which is to protected from the interface 200 (not represented) can be executed.

A resistance R12 represents e.g. metal dust, which causes an electrical short-circuit between the component 30 to be protected and a voltage source VCC_Bat. By means of a shunt R17, electric current flowing in the electronic component 30 can be metrologically detected by reference to an electric voltage drop wherein, by means of the gate terminal, an electronic switch 50 in the form of a MOSFET can be connected, in order to isolate the electronic component 30 from the battery voltage VCC_Bat by the opening of the electronic switch 50.

The right-hand section of the circuit in FIG. 2 represents a discrete latch circuit, wherein the two transistors Q3 and Q5 emulate a thyristor which “observes” a circuit state of the protective device 100 further to the disconnection of the electronic component 30. In the event that an electric overcurrent is detected by the electronic component 30, this state continues to be saved by means of the latch circuit, i.e. even if the current flowing in the electronic component 30 reduces to zero, the electronic switch 50 remains open, and thus prevents any reconnection of the electronic component 30 to the battery voltage VCC_Bat. For the resetting of the state saved by the latch circuit, the supply voltage VCC_Bat of the battery pack is disconnected. Resetting is executed, e.g. by the disconnection of VCC_Bat, or by a deactivation of the transistor Q5, wherein the base thereof is connected to ground via a control apparatus.

It is also conceivable, for example, for the evaluation of the electric voltage rise which, in the arrangement according to FIG. 2, is executed by means of the discrete shunt R17, to be executed by means of an AD converter and a monitoring apparatus 40 in the form of a microcomputer. To this end, on the microcomputer, an additional ADC input is required, wherein a software is employed for the detection of a fault state. Additional functions, such as e.g. auto-recovery, are also conceivable in this case.

It is also conceivable, for example, for the evaluation of the voltage rise which, in the arrangement according to FIG. 2, is executed by means of the discrete shunt R17, to be executed by means of a discrete latch circuit. Advantageously, in this manner, a software (not represented) is not involved in the detection and disconnection mechanism. The electronic component 30 to be protected remains disconnected from the interface 200 until such time as a short-circuit bridge is removed. Advantageously, this variant of the proposed protective device 100 is also self-resetting.

FIG. 3 shows a further embodiment of a proposed protective device 100 for an electrical interface 200. It can be seen that the NTC terminal of the electronic component 30 which is to be protected (not represented) is connected to a voltage divider R20, R21 which, in total, has a maximum resistance value, for example, of 1 MΩ. As a result, the electric voltage on the electronic component 30 to be protected is subdivided and fed to a non-inverting input of a comparator K1, at the output of which a transistor M3, for the actuation of the gate switch terminal of the electronic switch 50 (not represented) for the disconnection of the electronic component 30 (not represented), is operated. A switch-on threshold, at an operating voltage of 3.3 V, is approximately 6.6 V, and a switch-off threshold is approximately 0.6 V. A resistance R23, in combination with capacitors of the protective device 100, is appropriately dimensioned, wherein particular care is taken to ensure that the electronic component is disconnected from the interface 200 (not represented) in such a manner that there is no resulting damage to the electronic component.

In practice, in this manner, by means of the comparator K1, an evaluation of the voltage rise on the electronic component which is to be protected is executed wherein, advantageously, highly accurate trip thresholds can be set. By means of appropriate trip thresholds, this variant of the protective device 100 is also self-resetting.

FIG. 4 shows a further embodiment of a proposed protective device 100 for an electrical interface. A monitoring apparatus 40 can be seen, which is configured in the form of a Schmitt trigger, and comprises the transistors Q6, Q7. An output stage of the Schmitt trigger can further be seen, in the form of resistors R37, R38 and a MOSFET transistor M1 for the formation of an appropriate electrical level. The electronic component to be protected is not represented in FIG. 4. By means of this variant, an electric voltage V_NTC can be detected on the electronic component which is to be protected wherein, by the appropriate dimensioning of the resistors R30-R35, it can be achieved that a threshold of the Schmitt trigger is appropriately set, such that the latter switches a transistor M1 for the actuation of the electronic switch (not represented) for the disconnection of the electronic component which is to be protected.

In practice, in this variant, an evaluation of the electric voltage rise on the electronic component 30 which is to be protected is executed by means of a discrete Schmitt trigger, which permits the setting of accurate trip thresholds. By the achievement of appropriate trip thresholds, this variant of the protective device 100 is also self-resetting.

FIG. 5 shows a further embodiment of a protective device 100 for an electronic component, which resembles the variant according to FIG. 2 but wherein, in this case, a constant current source R17, J1 or a current limiting function by means of a N-channel JFET J1 and negative gate-source feedback coupling is provided. Advantageously, this variant requires only a very limited number of components, as a result of which, in practice, only limited space on the circuit board is required. This variant of the proposed protective device 100 is also self-resetting, or features a regulated/negative feedback mode.

It can also advantageously be provided that the evaluation of the electric voltage rise on the interface 200 is executed by means of an A/D converter and a microcontroller. In this case, the monitoring apparatus 40 is preferably configured in the form of a microcomputer, as a result of which, for example, the Schmitt trigger can be implemented in a software, in order to detect a fault condition on the electronic component 30. Advantageously, as a result, further functions can also be implemented, such as e.g. auto-recovery.

In a further variant, which is not represented in the figures, it can also be provided that the evaluation of the voltage rise on the electronic component 30 which is connected to the interface 200 is executed by means of a small-signal MOSFET. Advantageously, in this manner, it is also possible to set a more generous voltage range for the electric trip voltage to be employed for the switch-off of the electronic component 30 which is to be protected.

Advantageously, for those variants of the above-mentioned protective devices 100 which measure the electric voltage on the electronic component 30 which is to be protected, no latch circuit is required, as the electric voltage at the interface 200, further to the disconnection of the electronic component 30 which is to be protected, does not drop.

FIG. 6 shows a schematic sequence of a method for operating a proposed protective device for an electronic component 30 which is connected to an interface 200.

In a step 60, detection of an electric voltage and/or an electric current on the electronic component 30 is executed.

In a step 70, disconnection of the electronic component 30 from the electrical interface 200 is executed, in the event that an unacceptably high electric voltage is present on the electronic component 30, wherein a detected voltage which is at least double the nominal voltage constitutes an unacceptably high electric voltage and wherein, in the event that no further unacceptably high electric voltage is detected on the electronic component 30, the electronic component 30 is reconnected to the interface 200 by means of the electronic switch 50.

Typically, battery packs generally employ a temperature measurement circuit for the monitoring of cell temperature. This is frequently implemented in the form of a NTC on the battery electronics side, together with a contact element, via which a tool or a charging device having an appropriate series resistor applies a supply voltage to the NTC from the exterior. The NTC is thermally coupled to one or more cells. The voltage on the NTC contact correlates to the resistance/temperature of the NTC.

If, as illustrated in FIG. 7, as a result of contamination, a short-circuit KP is present between the positive pole 201 of the battery pack and the NTC contact 203, an electric current flows through the NTC, which is not limited by a defined series resistor. This results in the heat-up of the NTC as a result of which, due to its temperature response, its resistance is reduced. The electric current shows a continuous increase as a result. As the power loss is quadratically related to current (P=R×I²) , the power loss on the NTC increases as the NTC resistance reduces, as a result of which heat-up is further accelerated. On the grounds of thermal coupling with the cell, this can result in a hotspot on the cell, which can be associated with a thermal imbalance, disadvantageously resulting in the more rapid ageing of the electrical energy store 300, thereby causing associated issues.

It is proposed that this self-accelerating heat-up should be counteracted and that, in the fault scenario indicated, a secure state of the battery pack should be generated. To this end, it is proposed that a PTC element should be arranged within the temperature measurement circuit. In the event of the heat-up of the system in response to a short-circuit, the PTC also undergoes heat-up. The self-intensifying characteristic of the NTC (the resistance of which reduces with temperature) is thus counteracted by the self-limiting characteristic of the PTC (the resistance of which increases with temperature). This advantageously results in an intrinsically safe system, which requires no further logic components, e.g. a microprocessor. The proposed protective device 100 thus comprises a single component, i.e. is of minimal design complexity and, on the grounds of simplicity, is cost-effective, and can be implemented in a low-risk manner.

A proposed protective device 100 thus comprises a compensation element 31 in the form of a component having a positive temperature coefficient (e.g. a PTC), which is connected in series to the electronic component 30 (e.g. a NTC) at one pole (e.g. the negative pole 202) of the battery pack, or to a measuring contact 203 of the interface 200. In the “inactive” state, i.e. in the absence of a short-circuit on the measuring contact 203, the compensation element 31 assumes a low resistance, such that there is no relevant influence upon temperature measurement by means of the NTC. To this end, a resistance value is selected for the PTC which is small in relation to the NTC resistance value in the relevant operating range. In particular, switching thresholds (e.g. for disconnection in response to an overtemperature/excessively low temperature) should not be significantly corrupted as a result.

In the “active” state, i.e. in the presence of a short-circuit on the measuring contact 203, a state of equilibrium is established, according to the electric voltage present on the measuring contact 203 and the sum of all the series-connected resistors. In the high temperature range, the rise in resistance on the PTC is significantly greater than the drop in resistance on the NTC, as a result of which the total resistance rises, until an equilibrium is achieved.

This equilibrium temperature is configured such that there is no resulting hazard to other system components (typically, battery cells in the battery pack).

Advantageously, the compensation element 31 is thermally coupled to the NTC by means of the following appropriate technical measures:
Employment of SMD components for the component 30 to be protected and the compensation element 31, which are arranged in close proximity in the layout and/or are thermally coupled by means of an appropriate copper distribution arrangement;
Employment of components for the component 30 to be protected and the compensation element 31 having the smallest possible thermal capacities;
Employment of a thermally conductive material (e.g. a heat-conducting paste) for the exchange of heat between the component 30 to be protected and the compensation element 31.

By means of this thermal coupling, it is achieved that, by means of the compensation element 31 in the form of a PTC, a minimum electric current (or “trip current”) flows which is required for the purposes of “switching” (i.e. for the achievement of intrinsic heat-up which drives the PTC into a relevant high-resistance range). The lower the resistance of the PTC, the higher this trip current will be. By thermal coupling with the NTC, the PTC also undergoes heat-up, and thus increases its resistance, before the trip current has been achieved. This facilitates the selection of components in favor of low-resistance PTC components, which are conducive to the absence of any significant disturbance to temperature measurement.

Advantageously, the element to be protected 30 and the compensation element 31, with respect to their temperature coefficients of electrical resistance, are mutually matched. Consideration of the following will be required:
The influence upon temperature measurement of the additional PTC component in the measuring path;
Secure “switching” of the PTC in the event of the fault requiring protection, i.e. intrinsic heat-up in response to a sufficient current flux;
An equilibrium temperature, in the event of the fault requiring protection, which poses no hazard to the system as a whole.

FIG. 7 shows a schematic representation of a protective device 100 having contact elements and a series-connected arrangement comprised of the component 30 to be protected and the compensation element 31, which is connected between a measuring contact 203 and a negative pole 202. A potential short-circuit path KP between the positive pole 201 and the measuring contact 203 is indicated.

FIG. 8 shows an exemplary resistance characteristic, plotted against temperature, for mutually matched NTC and PTC elements according to the invention. It can be seen that the electrical resistance W of the electronic component 30 falls as the temperature rises and, at approximately 135° C., falls below the resistance of the compensation element 31. It can further be seen that the electrical resistance W of the compensation element 31 is essentially low, in comparison with the resistance of the electronic component 30, and increases as the temperature rises. The self-setting equilibrium temperature is dependent upon the temperature at which the negative gradient of the resistance curve of the electronic component 30 corresponds quantitively to the positive gradient in the resistance curve of the compensation element 31 which, in the example represented, is also approximately 135° C. At higher temperatures, this therefore signifies an increase in the overall resistance, and thus a reduction in the loss of power.

Advantageously, the proposed protective device 100 can also comprise control electronics (not represented) for the evaluation of temperature measurement.

Advantageously, an electrical energy store which is protected by means of the proposed protective device 100 can be configured in the form of an accumulator pack (e.g. a manual power tool accumulator pack).

The compensation element 31 can be connected directly or indirectly (for example, via a switch) to a pole 202, 203 of the battery pack.

A heat transfer resistance between the electronic component 30 and the compensation element 31 is preferably configured in a manner which is significantly conducive to the tripping of the PTC.

FIG. 9 shows a schematic sequence diagram of a proposed method for producing a protective device for an electronic component 30 connected to an interface 200, wherein an electrical energy store is connected to the interface 200.

In a step 80, connection of the component 30 to a pole or measuring contact 203 of the electrical energy store 300 is executed.

In a step 90, a series connection of a compensation element 31 between a pole 201, 202 of the electrical energy store and the electronic component 30, or between the electronic component 30 and a measuring contact 203 is executed, wherein the compensation element 31 assumes a positive temperature coefficient of electrical resistance, and wherein the component 30 and the compensation element 31 are thermally coupled to one another.

FIG. 13 shows a further embodiment of a proposed protective device 100. The temperature of the cells 310a . . . 301n is detected by the arrangement of a management apparatus 400, which is arranged externally to the electrical energy store 300, by means of an electronic component 30 which is arranged in the electrical energy store 300 in the form of a NTC temperature sensor. However, as the management apparatus 400 only assumes a function for the detection of the electric voltage at the interface 200, and is not essential to the invention, no further details thereof are addressed here. Alternatively, the electronic component 30 might also be configured in the form of a coding resistor.

The electrical energy store 300 is further provided with a monitoring apparatus 40 having electronics (e.g. a microcontroller) for the monitoring of individual cells 301a . . . 301d. In the event of the detection of a fault by the monitoring apparatus 40, the latter isolates the electronic component from the interface 200 by means of an electronic switch 50 in the form of a transistor which is connected in series with the electronic component 30.

A further resistor 32 (“measuring resistor”) can be seen, which is connected in series with the electronic switch 50. The monitoring apparatus 40 is provided with an input 41, via which it can detect an electric voltage on the measuring resistor 32. If, in the event of a fault, a high electric current flows through the series-connected arrangement of the electronic component 30, the electronic switch 50 and the measuring resistor 32, this results in an electric voltage drop on the measuring resistor 32, which is detected by the monitoring apparatus 40 at the input 41. In response, the monitoring apparatus 40 switches the electronic switch 50 to a blocking state, such that the above-mentioned electric current flux is interrupted.

Advantageously, the monitoring apparatus 40 can maintain this blocking state for a minimum time, for example longer than 1 s and, particularly advantageously, longer than one minute. In this manner, it can advantageously be prevented that the electronic switch 50 is reclosed immediately, on the grounds that, in the event of the interruption of the electric current, the electric voltage on the input 41 of the monitoring apparatus 40 is also close to zero, and would thus be evaluated as uncritical.

A particular advantage of this proposed protective device 100 is provided in that the measuring resistor 32 can have a very small rating, and thus only corrupts actual temperature measurement by means of the electronic component 30 to a minimal extent. A resistance value of less than 1% of the minimum value of the electronic component 30 over the entire operating temperature range of the electrical energy store 300 is advantageous, wherein a resistance value of less than 0.3% of the minimum value of the electronic component 30 over the entire operating temperature range of the electrical energy store 300 is particularly advantageous. For example, the measuring resistor 32 can have a rating of 1 ohm, whereas the rating of a fuse for a low electric current of this type is typically 10 ohms. The monitoring apparatus 40 is not required to be capable of detecting an electric current flow in the electronic component 30 in normal duty, but only in the event of an overcurrent fault.

As a result, this variant of the proposed protective device 100 can be realized in a particularly cost-effective and simple manner.

Integrated circuits are known, having inputs which are provided for battery current measurement and which, in the event of an excessively high electric current, assume an alarm state. An integrated circuit of this type is also appropriate for employment in the arrangement according to FIG. 13, wherein a current input of the monitoring apparatus 40 is thus employed as a measuring input. An excessively high electric current flow in the electronic component 30 will then be interpreted by such a monitoring apparatus 40 as an excessively high battery current, which will also result in the tripping of an alarm.

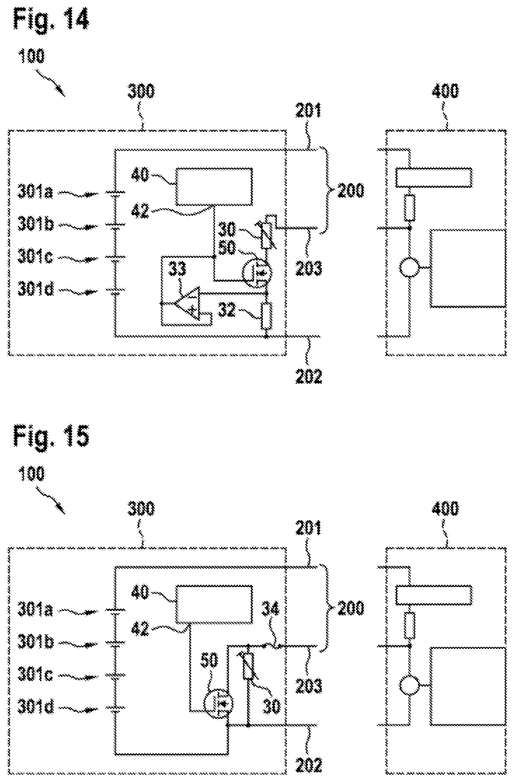

FIG. 14 shows a schematic circuit diagram of a further embodiment of a proposed protective device 100. It will be seen that, in this variant, an independent circuit based upon a comparator circuit 33 (Schmitt trigger) can interrupt the electric current flow in the electronic component 30. An additional circuit connection of the amplification device 33, e.g. via appropriate resistors, is not represented. The electric voltage drop across the measuring resistor 32 triggers a variation in the output level on the comparator circuit 33 to a value close to zero V. This switches the gate or base of the electronic switch 50 to “low”, such that the electronic switch 50 is no longer conductive, independently of the output 42 (alarm output) of the monitoring apparatus 40. The comparator circuit 33 is thus provided with direct feedback, such that it maintains its state (i.e. output at zero V), even where the measuring signal is no longer present on the input. This variant can be particularly appropriate if no further input is available on the monitoring apparatus 40 and/or the monitoring apparatus 40 assumes no current monitoring function.

FIG. 15 shows a schematic circuit diagram of a further embodiment of a proposed protective device 100. This variant will be particularly preferred if the system is designed to the bridge the electronic component 30, in the form of the NTC temperature sensor, in the event of a fault. A protective element 34 (e.g. a fuse) can be seen, arranged in series with the electronic component 30, to which the electronic switch 50 is connected in parallel. A particular feature of this fuse is provided, in that it is not necessary for it to be rated for the electric current which flows in the electronic component 30 in the event of a fault, but for a higher electric current. In normal duty, the protective element 34 is not tripped. This is therefore advantageous, as the protective element 34 can thus assume a low electrical resistance, and only minimally corrupts temperature measurement in normal duty.

It is provided that, in normal duty, the monitoring apparatus 40 engages the electronic switch 50 in a cyclical or sporadic manner, for a specific and short time interval. This time interval is selected to be sufficiently short, such that the connected management apparatus 400 (tool or charging device) does not yet detect the latter as a fault. For example, this cycle time can be 50 ms.

In the event that a high electric voltage is now present on the input contact of the electronic component 30, the conductivity of which is not limited, the electronic switch 50, during this time, will release a path for a high electric current, which is appropriate for the tripping or destruction of the protective element 34.

For example, the protective element 34 can be configured in the form of a trace resistor. According to IPC-2221, e.g. with a trace width of 0.1 mm, a temperature increase of 60° can be produced at 1.1 A. Alternatively, the protective element 34 can also be configured in the form of a fusible resistor.

FIG. 16 shows a schematic sequence diagram of a method for operating a protective device 100 for an electronic component 30 which is connected to an interface 200.

In a step 500, detection of an electric voltage drop on a measuring resistor 32 which is connected in series with the electronic component 30 is executed.

In a step 510, disconnection of the electronic component 30 is executed in the event of an overshoot by the electric voltage drop of a specified trip threshold.

1. A protective device for an electronic component connected to an interface, comprising:
a compensation element connected in series with the electronic component,
wherein the compensation element has a positive temperature coefficient of an electrical resistance of the compensation element,
wherein the compensation element is connected to a pole of an electrical energy store, via the interface, at a pole or a measuring contact, and
wherein the electronic component and the compensation element are thermally coupled to one another.

2. The protective device as claimed in claim 1, wherein the electronic component is a coding resistor and/or the electronic component is configured with a negative temperature coefficient.

3. The protective device as claimed in claim 1, wherein the thermal coupling of electronic component and the compensation element is provided by a specific spatial proximity, by a printed electrical conductor configured to connect the electronic component and the compensation element, or by a specific heat transfer resistance between the electronic component and the compensation element.

4. The protective device as claimed in claim 2, wherein the thermal coupling between the electronic component and the compensation element is conducive to tripping of the compensation element in response to heating of the electronic component.

5. The protective device as claimed in claim 1, wherein:
the electronic component is configured for a temperature measurement,
the electronic component and the compensation element, with respect to their corresponding temperature coefficients, are mutually tuned such that, within a relevant temperature measurement range, the temperature measurement is not significantly corrupted, and
wherein, outside the relevant temperature measurement range, the compensation element is defined as high-resistance.

6. The protective device as claimed in claim 5, wherein the relevant temperature measurement range is from −20° C. to +80° C.

7. The protective device as claimed in claim 5, wherein:
an equilibrium temperature of the electronic component and the compensation element is such that, at a maximum operating voltage of an electrical energy store, cells of the electrical energy store are not endangered, and
the equilibrium temperature is dependent upon a point of intersection of gradients of characteristic curves for the electronic component and the compensation element.

8. The protective device as claimed in claim 1, wherein a temperature measurement error associated with a resistance measurement of the electronic component and the compensation element, within an entire temperature working range of the electrical energy store, is established at a maximum defined value.

9. The protective device as claimed in claim 1, wherein a resistance value of the compensation element is defined as small in comparison to a resistance value of the electronic component.

10. The protective device as claimed in claim 5, wherein an error in temperature measurement generated by the compensation element is not greater than 5%.

11. The protective device as claimed in claim 1, wherein the electronic component and the compensation element are coupled by a thermally conductive material.

12. The protective device as claimed in claim 11, wherein:
the electronic component and the compensation element are configured as surface mount devices (SMD), and
the electronic component and the compensation element comprise at least one common copper surface configured for heat transfer.

13. An electrical energy store, comprising:
a protective device for an electronic component connected to an interface, the protective device comprising a compensation element connected in series with the electronic component,
wherein the compensation element has a positive temperature coefficient of an electrical resistance of the compensation element,
wherein the compensation element is connected to a pole of an electrical energy store, via the interface, at a pole or a measuring contact, and
wherein the electronic component and the compensation element are thermally coupled to one another.

14. A method for producing a protective device for an electronic component connected to an interface, wherein an electrical energy store is connected to the interface, comprising:
connecting the electronic component to a pole or measuring contact of the electrical energy store; and
serially connecting a compensation element between one pole of the electrical energy store and the electronic component, or between the electronic component and a measuring contact,
wherein the compensation element has a positive temperature coefficient of electrical resistance of the compensation element; and
wherein the electrical component and the compensation element are thermally coupled to one another.
